(19) United States
(12) Patent Application Publication
(10) Pub. No.: US 2026/0050823 A1
(43) Pub. Date: Feb. 19, 2026

(54) ENCODING GRAPH NETWORK EVOLUTIONS USING SEQUENCES

(71) Applicant: Microsoft Technology Licensing, LLC, Redmond, WA (US)

(72) Inventors: Parag Agrawal, Santa Clara, CA (US); Aman Gupta, San Jose, CA (US); Zhanglong Liu, Fremont, CA (US); Ankan Saha, New York, NY (US); Viral Gupta, Lathrop, CA (US)

(21) Appl. No.: 18/807,671

(22) Filed: Aug. 16, 2024

(51) Int. Cl. G06N 20/00

(52) U.S. Cl. CPC G06N 20/00

(57) ABSTRACT

Methods, systems, and apparatuses include receiving an event notification for an event associated with a node of a graph network. Event data including node state data and a timestamp is generated using the event notification. A node state change is generated for the node by applying a neural network to the node state data and the timestamp. An input sequence for a generative machine learning model is generated, the input sequence including the node state change and the node state data. Updated node state data is computed for the node by applying the generative machine learning model to the input sequence. A node encoding is generated for the node using the updated node state data. Input data for a trained machine learning model is generated using the node encoding. An output of the trained machine learning model is generated by applying the trained machine learning model to the input data.

### TECHNICAL FIELD

The present disclosure generally relates to machine learning, and more specifically, relates to approaches to generating encodings using machine learning.

### BACKGROUND ART

Machine learning is a category of artificial intelligence. In machine learning, a model is defined by a machine learning algorithm. A machine learning algorithm is a mathematical and/or logical expression of a relationship between inputs to and outputs of the machine learning model. The model is trained by applying the machine learning algorithm to input data. A trained model can be applied to new instances of input data to generate model output. Machine learning model output can include a prediction, a score, or an inference, in response to a new instance of input data. Application systems can use the output of trained machine learning models to determine downstream execution decisions, such as decisions regarding various user interface functionality.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes an event preprocessing component in accordance with some embodiments of the present disclosure.

FIG. 2 illustrates another example computing system that includes an event preprocessing component in accordance with some embodiments of the present disclosure.

FIG. 3 illustrates another example computing system that includes an event preprocessing component in accordance with some embodiments of the present disclosure.

FIG. 4 illustrates another example computing system that includes an event preprocessing component in accordance with some embodiments of the present disclosure.

FIG. 5 illustrates an example computing system that includes a node aggregation component in accordance with some embodiments of the present disclosure.

FIG. 6 is a flow diagram of an example method to generate encodings for graph network evolutions in accordance with some embodiments of the present disclosure.

FIG. 7 is a block diagram of an example computer system in which embodiments of the present disclosure can operate.

### DETAILED DESCRIPTION

Machine learning-enabled node encoder systems can generate encoding representations of nodes within a network. For example, online systems with large amounts of content (e.g., social media systems with hundreds of thousands and/or millions of posts and/or social media systems with hundreds of thousands and/or millions of users) can use these node encoder systems to represent the relationships between different pieces of content (e.g., entities and/or nodes). These systems can use graph neural networks (GNN) to generate encodings for a node based on the node's relationships to other nodes within the network. Conventional systems rely on training machine learning models that use node states as parameters. By using node states as parameters, these conventional systems are not able to response to trending events (e.g., a lot of events happening in a short period of time) because the need to re-train the models results in high latency. This leads to stale results and requires a large amount of storage since the parameters of these models (e.g., the node states) must be stored in memory. Additionally, as the amount of data available on these online networks increases, these shortcomings become more acute. For example, as the size of node states increases (representing more information regarding the node), the amount of memory required to run these models and the latency for training and processing these models increases as well.

A node encoding system using generative machine learning models to encode graph network evolutions, as described herein includes a number of different components that alone or in combination address the above and other shortcomings of the conventional machine learning systems, particularly when applied to environments with large online networks. For example, by modeling events themselves as neural networks which take the previous states for nodes involved in the events and timestamps for the events as inputs, the node encoding system is able to reduce the response time for the entire system (e.g., because encoding nodes for an event only requires scoring a neural network rather than training a machine learning model). Additionally, by using the node states as inputs as opposed to parameters, the encoding system does not need to store the node states in memory. Overall, this results in a system that has a faster response time, leading to lower latency, higher throughput, and reduced memory. Because of the lower latency and higher throughput, the encoding system is more responsive to events, allowing the encoding system to properly represent updates to node states for trending events and/or events happening in real-time.

Additionally, by representing events as neural networks, the node encoding system is event-focused, allowing the use of transformer models and their associated self-attention mechanisms. By using these transformer models, the node encoding system can generate node encodings based on the most relevant time period for a node state (rather than just the most recent). For example, the transformer model can determine (e.g., through self-attention) whether more recent or older node states are more important for the changes and can therefore generate node encodings which can represent either recent events, older events, or combinations of both. This flexibility mirrors the rapid evolution of social networks and their associated social graphs and allows the encoding system to be responsive to changed network trends either in the short-term or the long-term.

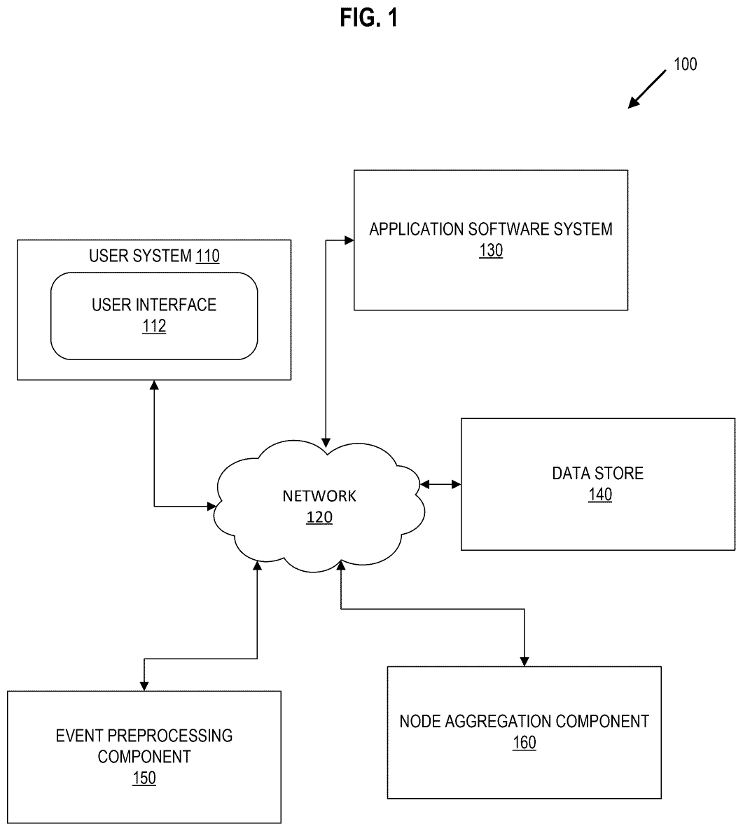

FIG. 1 illustrates an example computing system 100 that includes an event preprocessing component 150 in accordance with some embodiments of the present disclosure. In the embodiment of FIG. 1, computing system 100 includes a user system 110, a network 120, an application software system 130, a data store 140, an event preprocessing component 150, and a node aggregation component 160. Each of these components of computing system 100 are described in more detail below. In some embodiments, the components of computing system 100 and their respective subcomponent are implemented on one or more of user devices, cloud servers and/or databases, and combinations thereof.

User system 110 includes at least one computing device, such as a personal computing device, a server, a mobile computing device, or a smart appliance. User system 110 includes at least one software application, including a user interface 112, installed on or accessible by a network to a computing device. For example, user interface 112 can be or include a front-end portion of application software system 130.

User interface 112 is any type of user interface as described above. User interface 112 can be used to interact with a chat interface and view or otherwise perceive output that includes data produced by application software system 130. For example, user interface 112 can include a graphical user interface and/or a conversational voice/speech interface that includes a mechanism for entering a query to a chat interface and viewing chat query results and/or other digital content. Examples of user interface 112 include web browsers, command line interfaces, and mobile apps. User interface 112 as used herein can include application programming interfaces (APIs).

Network 120 can be implemented on any medium or mechanism that provides for the exchange of data, signals, and/or instructions between the various components of computing system 100. Examples of network 120 include, without limitation, a Local Area Network (LAN), a Wide Area Network (WAN), an Ethernet network or the Internet, or at least one terrestrial, satellite or wireless link, or a combination of any number of different networks and/or communication links.

Application software system 130 is any type of application software system that includes or utilizes functionality and/or outputs provided by event preprocessing component 150 and/or node aggregation component 160. Examples of application software system 130 include but are not limited to online services including connections network software, such as social media platforms, and systems that are or are not be based on connections network software, such as general-purpose search engines, content distribution systems including media feeds, bulletin boards, and messaging systems, special purpose software such as but not limited to job search software, recruiter search software, sales assistance software, advertising software, learning and education software, enterprise systems, customer relationship management (CRM) systems, or any combination of any of the foregoing.

A client portion of application software system 130 can operate in user system 110, for example as a plugin or widget in a graphical user interface of a software application or as a web browser executing user interface 112. In an embodiment, a web browser can transmit an HTTP (HyperText Transfer Protocol) request over a network (e.g., the Internet) in response to user input that is received through a user interface provided by the web application and displayed through the web browser. A server running application software system 130 and/or a server portion of application software system 130 can receive the input, perform at least one operation using the input, and return output using an HTTP response that the web browser receives and processes.

While not specifically shown, it should be understood that any of user system 110, application software system 130, data store 140, event preprocessing component 150, and node aggregation component 160 includes an interface embodied as computer programming code stored in computer memory that when executed causes a computing device to enable bidirectional communication with any other of user system 110, application software system 130, data store 140, event preprocessing component 150, and node aggregation component 160 using a communicative coupling mechanism. Examples of communicative coupling mechanisms include network interfaces, inter-process communication (IPC) interfaces and application program interfaces (APIs).

Data store 140 can include any combination of different types of memory devices. Data store 140 stores digital data used by user system 110, application software system 130, event preprocessing component 150, and/or node aggregation component 160. Data store 140 can reside on at least one persistent and/or volatile storage device that can reside within the same local network as at least one other device of computing system 100 and/or in a network that is remote relative to at least one other device of computing system 100. Thus, although depicted as being included in computing system 100, portions of data store 140 can be part of computing system 100 or accessed by computing system 100 over a network, such as network 120.

Each of user system 110, application software system 130, data store 140, event preprocessing component 150, and node aggregation component 160 is implemented using at least one computing device that is communicatively coupled to electronic communications network 120. Any of user system 110, application software system 130, data store 140, event preprocessing component 150, and node aggregation component 160 can be bidirectionally communicatively coupled by network 120. User system 110 as well as one or more different user systems (not shown) can be bidirectionally communicatively coupled to application software system 130.

A typical user of user system 110 can be an administrator or end user of application software system 130, event preprocessing component 150, and/or node aggregation component 160. User system 110 is configured to communicate bidirectionally with any of application software system 130, data store 140, event preprocessing component 150, and/or node aggregation component 160 over network 120.

The features and functionality of user system 110, application software system 130, data store 140, event preprocessing component 150, and node aggregation component 160 are implemented using computer software, hardware, or software and hardware, and can include combinations of automated functionality, data structures, and digital data, which are represented schematically in the figures. User system 110, application software system 130, data store 140, event preprocessing component 150, and node aggregation component 160 are shown as separate elements in FIG. 1 for ease of discussion but the illustration is not meant to imply that separation of these elements is required. The illustrated systems, services, and data stores (or their functionality) can be divided over any number of physical systems, including a single physical computer system, and can communicate with each other in any appropriate manner.

The event preprocessing component 150 generates new states for nodes of a graph network using event data. For example, event preprocessing component 150 generates a neural network representation of a change to a node of a graph network based on event data involving that node and generates new node states for that node and neighboring nodes by applying a generative machine learning model (e.g., a transformer, encoder-decoder, or similar machine learning model) to the neural network representation and the states for that node and the neighboring nodes. Further details regarding the operations of event preprocessing component 150 are described below.

The node aggregation component 160 aggregates the new node states from the transformer and generates an encoding for the node using the new node states. Further details regarding the operations of node aggregation component 160 are described below.

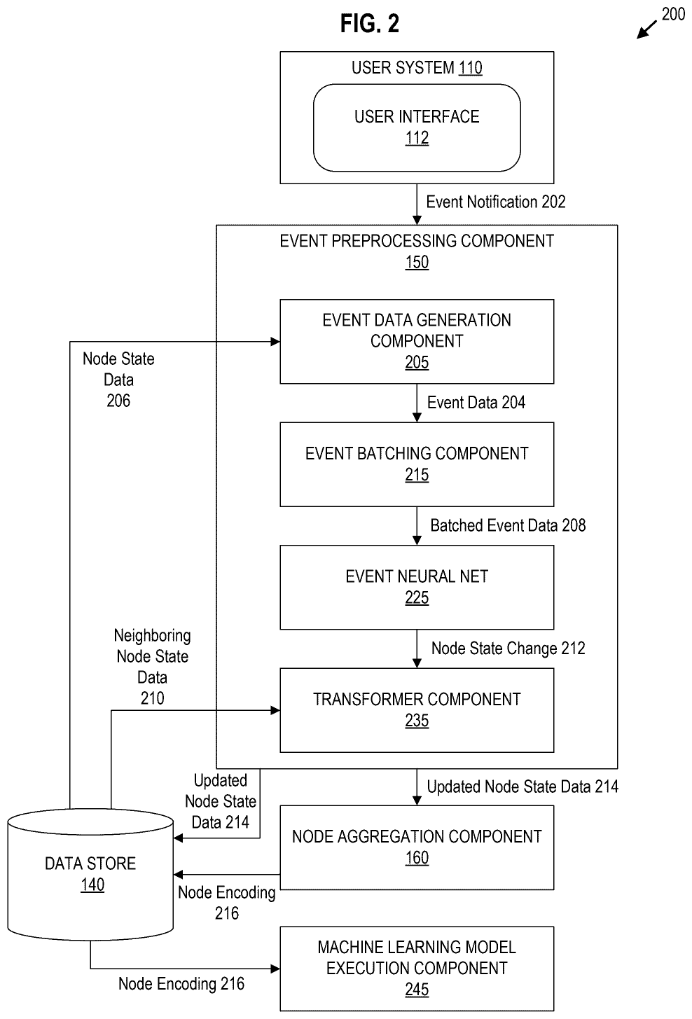

FIG. 2 illustrates another example computing system 200 that includes an event preprocessing component in accordance with some embodiments of the present disclosure. As shown in FIG. 2, computing system 200 also includes user system 110, application software system 130, data store 140, node aggregation component 160, and machine learning model execution component 245. Event preprocessing component 150 includes event data generation component 205, event batching component 215, event neural net 225, and transformer component 235. Although described as a transformer component, transformer component 235 can include any kind of machine learning model for generating updated state data.

As shown in FIG. 2, event preprocessing component 150 receives event notification 202 from user system 110. For example, user system 110 sends event notification 202 in response to a user of user system 110 interacting with content presented on user interface 112. In one embodiment, in response to a user interacting with user interface 112 to like a post on a social network, user system 110 sends event notification 202 indicating that the user liked the post to event preprocessing component 150. For example, user system 110 sends event notification 202 to event preprocessing component 150 including a user identifier for the user (e.g., user of user system 110), an action identifier for the action (e.g., a like), an object identifier for the recipient of the action (e.g., the post that was liked), and a timestamp for a time the event occurred. In some embodiments, event notification 202 does not include an object identifier. For example, in response to a new user creating a profile, user system 110 sends event notification 202 including the new user identifier, the action (e.g., create), and the timestamp.

Event preprocessing component 150 receives event notification 202 and event data generation component 205 of event preprocessing component 150 generates event data 204 using event notification 202. For example, in response to receiving event notification 202 including a user identifier, an action identifier, an object identifier, and a timestamp, event data generation component 205 retrieves node state data 206 for a node of a graph network involved in the event. In some embodiments, event data generation component 205 retrieves node state data 206 from data store 140 for a node involved in the event. For example, data store 140 includes state data for nodes (e.g., users, posts, jobs, skills, etc.) of a graph network. This state data can include, for example, a multi-dimensional vector representing the node (e.g., features of the node) and its relationship to other nodes in the graph network (e.g., shared edges, etc.) at a given time. These nodes include entities of the graph network (e.g., users, posts, jobs, skills, etc. as mentioned above) such as a graph network for an online social media site. The state data for the nodes of this graph network can therefore include data about the nodes themselves (e.g., profile data for a user) and/or data about the past interactions of the nodes (e.g., how the node is connected to other nodes of the graph network). In one embodiment, the state data is a 500-dimension vector representing a node at a given time. Data store 140 can include the most recent state data for a node and update the state data in response to events as explained below.

In some embodiments, event data generation component 205 generates event data 204 including node state data 206 for the nodes involved in the event and a timestamp of the event (e.g., the timestamp from event notification 202). In some embodiments, event data generation component 205 generates the timestamp for the event by converting the timestamp from event notification 202 into a vector. For example, event data generation component 205 generates a timestamp by using a time2vec function on the time from event notification 202. The state data for a node i prior to a timestamp t can be represented as hᵢ(t−) and the state data for a node j prior to a timestamp t can be represented as hⱼ(t−). In some embodiments, event data 204 also includes an event type for the event. For example, the event type (represented as type) can include the action identifier of event notification 202 identifying the type of event that occurred. Event types can include, for example: like, comment, post, share, create, delete, etc. Event data generation component 205 sends event data 204 (e.g., hᵢ(t−), hⱼ(t−), t, type) to event batching component 215.

Event batching component 215 receives event data 204 and generates batched event data 208. In some embodiments, event batching component 215 generates batched event data 208 at certain time intervals. For example, event batching component 215 generates batched event data 208 including event data received during the relevant time period two times a day. In some embodiments, event batching component 215 generates batched event data 208 in response to the amount of event data reaching a threshold. For example, event batching component 215 generates batched event data 208 in response to receiving a threshold amount of event data for a node.

In some embodiments event batching component 215 generates batched event data 208 using usage data for the node. For example, event batching component 215 retrieves usage data indicating when the relevant nodes receive interactions from data store 140 for the relevant nodes and generates batched event data 208 upon determining that the relevant nodes are not likely to receive further interactions based on the usage data. In one embodiment, for example, event batching component 215 determines that a user represented by a node is active during a certain period of time based on the usage data and generates batched event data 208 for the node representing that user in response to the expiration of the active period of time. The batched event data for a node i for a batch timestamp t_{batch} can be represented as hᵢ(t_{batch}−) (including state data for all timestamps t₁−t_{batch}), the state data for a node j for a batch timestamp t_{batch} can be represented as hⱼ(t_{batch}−) (including state data for all timestamps t₁−t_{batch}), and the event types for the events during the batch time can be represented as type (including type for all timestamps t₁-t_{batch}). Event batching component 215 sends batched event data 208 (e.g., hᵢ(t_{batch}−), hⱼ(t_{batch}−), t_{batch}, type_{batch}) to event neural net 225.

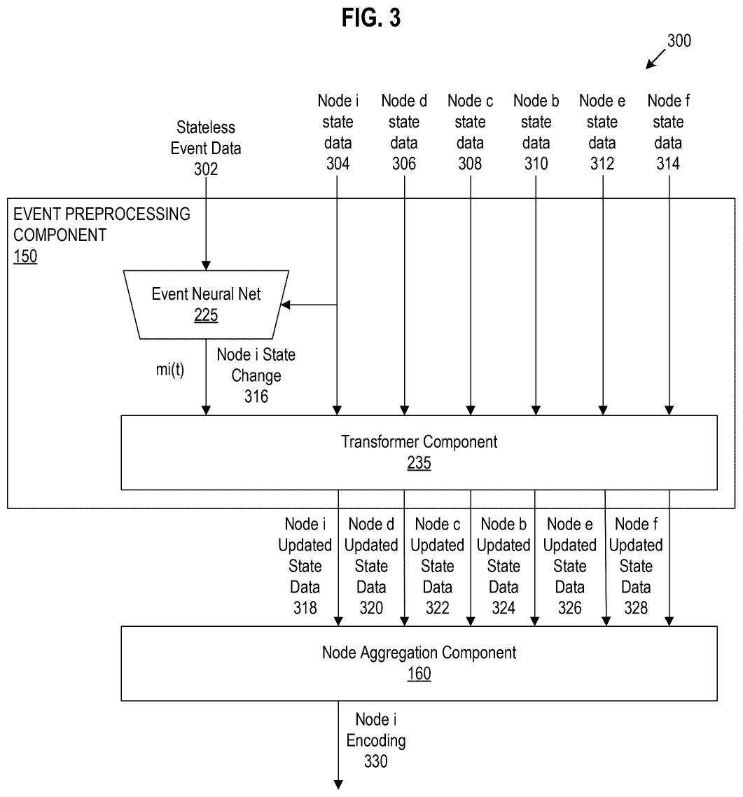

Event neural net 225 receives batched event data 208 and generates node state change 212 representing a change to the neural network representation of the relevant node in response to the events. For example, event neural net 225 generates node state change 212 for a node i, represented as mᵢ(t_{batch}) by applying an event function to the previous state of node i (e.g., hᵢ(t_{batch}−), the timestamp (e.g., t_{batch}), and the event type (e.g., type batch). In some embodiments event neural net 225 also uses the previous state of node j (e.g., hⱼ(t_{batch}−)) as an input to the event function. For example, if the event involved two nodes, event neural net 225 uses the previous state of both nodes as inputs to the event function. In some embodiments, event neural net 225 uses additional data as inputs to the event function. For example, event neural net 225 can use a device identifier for a device that initiated the event (e.g., user system 110), position data (e.g., a position vector) identifying the source and target of the action of the event (e.g., data identifying whether node i or node j caused the event), and other data relating to the event. In some embodiments, node state change 212 includes the state change for the other node involved in the event. For example, event neural net 225 generates node state change 212 for a node j, represented as mⱼ(t_{batch}) by applying the event function to input data as described above. Accordingly, event neural net 225 can generate node state change 212 represented as mᵢ(t_{batch}) and mⱼ(t_{batch}), where mᵢ(t_{batch})=event(hᵢ(t_{batch}−), hⱼ(t_{batch}−), t_{batch}, type_{batch}) and mⱼ(t_{batch})=event(hⱼ(t_{batch}−), hᵢ(t_{batch}−), t_{batch}, type_{batch}). Further details regarding event neural net 225 and node state change 212 are described with reference to FIG. 3. Event neural net 225 sends node state change 212 (e.g., mᵢ(t_{batch}), mⱼ(t_{batch})) to transformer component 235. In some embodiments, transformer component 235 and/or event batching component 215 sends batched event data 208 to transformer component 235. For example, event batching component 215 and/or event neural net 225 sends the batched node states (e.g., hᵢ(t_{batch}−) and hⱼ(t_{batch}−)) for the nodes involved in the event (e.g., node i and node j). Further details regarding node event neural net 225, node state change 212, and batched event data 208 are described with reference to FIG. 3. Because the event is modeled as a neural network which takes the previous states of the involved nodes, timestamp, and event type as inputs, the system is highly responsive to events and node changes because generating an encoding (e.g., node encoding 216) relies on scoring a neural net (e.g., representing the event) rather than requiring periods of training. For example, rather than training a machine learning model using the node states as parameters of the model, the node states are instead used as inputs to the neural net, allowing for a faster and more responsive encoding operation.

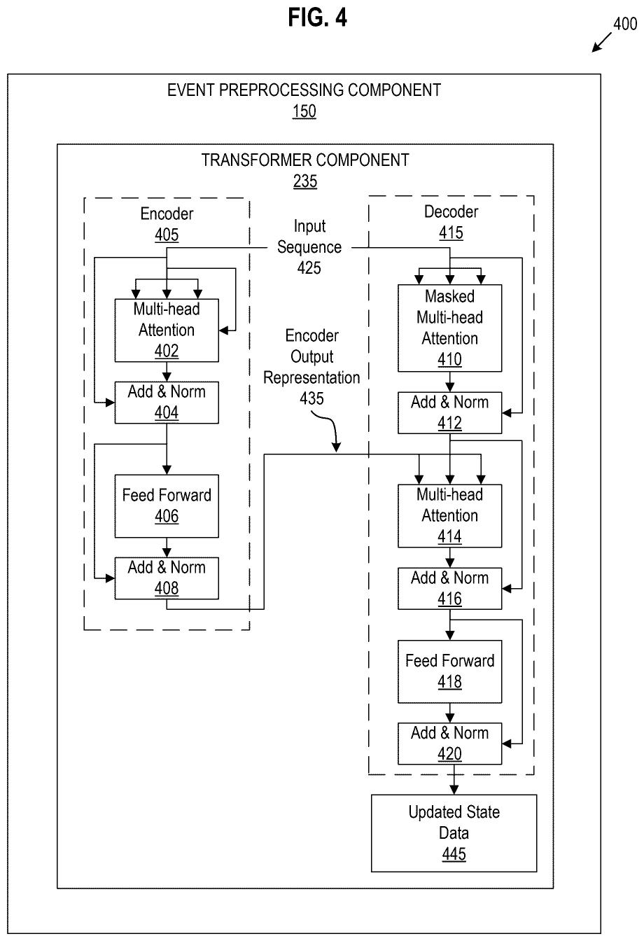

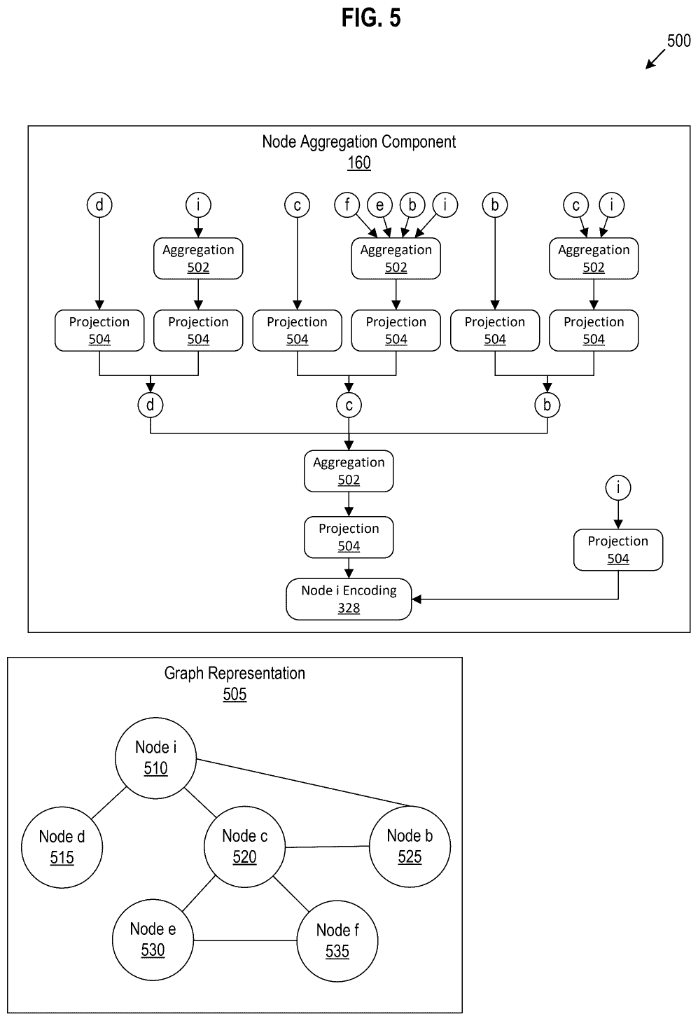

Transformer component 235 receives node state change 212 and generates updated node state data 214. In some embodiments, transformer component 235 retrieves node state data 206 from data store 140. In some embodiments, as shown in FIG. 2, transformer component 235 retrieves neighboring node state data 210 from data store 140. For example, transformer component 235 retrieves node state data for nodes that neighbor (e.g., are connected to/share an edge with) the nodes involved in the event (e.g., node i and/or node j). In some embodiments, transformer component 235 retrieves neighboring node state data 210 based on a neighbor distance for the nodes involved in the event. For example, for a neighbor distance of two, transformer component 235 retrieves neighboring node state data 210 for nodes that are one or two connections (e.g., edges) away from the nodes involved in the event. Further details regarding neighbor distance are described with reference to FIG. 5. Transformer component 235 generates input sequences for a trained transformer machine learning model using node state change 212 and neighboring node state data 210. Transformer component 235 computes updated node state data 214 by applying the trained transformer model to the generated input sequences. For example, transformer component 235 computes updated node state data 214 for a node i, represented as hᵢ(t_{batch}) by applying a transformer function represented the trained transformer machine learning model to the previous state of node i (e.g., hᵢ(t_{batch}−) and the node state change for the node (e.g., mᵢ(t_{batch})). Accordingly, transformer component 235 computes updated node state data 214 represented as hᵢ(t_{batch}), where hᵢ(t_{batch})=transformer (hᵢ(t_{batch}−), mᵢ(t_{batch})). Further details regarding transformer component 235 are described with reference to FIGS. 3 and 4. Transformer component 235 sends updated node state data 214 (e.g., hᵢ(t_{batch})) to node aggregation component 160. It will be appreciated that while the example describes updated node state data 214 for a single node (e.g., node i) for simplicity, updated node state data 214 includes updated state data for node i and the neighboring nodes (e.g., determined by neighbor distance). In some embodiments, event preprocessing component 150 sends updated node state data 214 to data store 140 for storage and future retrieval. For example, updated node state data 214 can be used as node state data 206 for future events.

By applying a transformer machine learning model to input sequences including node state data 206 (e.g., state data capturing the node's past interactions) and node state change 212 (which represents the change in the node state data over time as a result of the events), the transformer machine learning model is able to generate updated node state data 214 for the node which can appropriately focus on either the most recent interactions (e.g., focus on states of the node in the last day) or much older interactions (e.g., focus on states of the node from the last year).

Node aggregation component 160 receives updated node state data 214 and generates node encoding 216 using the updated node state data 214. For example, node aggregation component 160 generates a node encoding 216 for node i (represented by zᵢ(t_{batch})) by applying a graph neural network machine learning model to the updated node state data 214 for node i and its neighboring nodes. For example, node encoding 216 is a vector representation of node i and its neighboring nodes, such that node encoding 216 includes information about the relationship between node i and its neighboring nodes. In one embodiment, node aggregation component 160 aggregates updated node state data 214 for node i with learned weights applied to the updated node state data 214 for node i and its neighboring nodes. Further details regarding the graph neural network, node aggregation component 160, and node encoding 216 are described with reference to FIG. 5. Node aggregation component 160 sends node encoding 216 to data store 140. For example, node aggregation component 160 sends node encoding 216 for storage and later use. In some embodiments, although not illustrated, node aggregation component 160 sends node encoding 216 directly to machine learning model execution component 245.

Machine learning model execution component 245 receives node encoding 216 from node aggregation component 160 and generates input data for a trained machine learning model using node encoding 216. For example, machine learning model execution component 245 can include recommendation machine learning models which use node encoding 216 to generate recommendations for a user associated with the node based on the nodes position in the graph neural network as captured by node encoding 216. For example, the recommendation machine learning model can compare node encoding 216 for a user with node encoding for other entities (e.g., other users, job postings, companies, etc.) and generate recommendations for the user associated with node encoding 216 based on the distance between node encoding 216 and the node encoding for the recommended entities. In some embodiments, machine learning model execution component 245 includes a search result machine learning model. In such an embodiment, machine learning model execution component 245 can use node encoding 216 as well as a search query entered by a user associated with node encoding 216 to generate results to the search query. Additionally, machine learning model execution component 245 can use node encoding node encoding 216 to include the entity associated with node encoding 216 in a search by another user. In some embodiments, machine learning model execution component 245 generates an output using the input data. For example, machine learning model execution component 245 generates recommendations for a user of user system 110 and/or a search result for a user of user system 110.

FIG. 3 illustrates another example computing system 300 that includes an event preprocessing component in accordance with some embodiments of the present disclosure. As shown in FIG. 3, computing system 300 also includes node aggregation component 160. Event preprocessing component 150 includes event neural net 225 and transformer component 235.

Although described in FIG. 2 as batched data, for simplicity, the following description will focus on operations for a single event and therefore a single time t. Accordingly, as shown in FIG. 3, event preprocessing component 150 inputs stateless event data 302 and node i state data 304 into event neural net 225. Although illustrated separately for explanation, stateless event data 302 (e.g., t, type) and node i state data 304 (e.g., hᵢ(t−)) can be included together as inputs to event neural net 225 (e.g., batched event data 208 of FIG. 2). Event preprocessing component 150 generates node i state change 316 (e.g., mᵢ(t)) by applying event neural net 225 to inputs stateless event data 302 and node i state data 304 to determine how the state changes over time in response to the event described by inputs stateless event data 302. For example, event neural net 225 computes mᵢ(t)=event(hᵢ(t−), t, type) where event represents the application of event neural net 225 to inputs stateless event data 302 and node i state data 304. In some embodiments, event neural net 225 is a 2-layer feed-forward neural network. Node i state change 316 output by event neural net 225 reflects the changes to the state of node i in response to the event. For example, node i state data 304 is a 500-dimension vector representing an entity associated with node i. The entity can be, for example, a user, a company, a post, a job posting, a skill, etc. Accordingly, the state data for the node captures the known data for this entity (e.g., how active the entity is, the entities affiliation with certain topics, companies, users, job postings, etc.). Node i state change 316 therefore reflects how this state data changes in response to the event. For example, it may include information indicating that the entity associated with node i is more active, more interested in a certain topic, etc. Event neural net 225 sends node i state change 316 (e.g., mᵢ(t)) to transformer component 235.

Transformer component 235 receives node i state change 316 (e.g., mᵢ(t)) from event neural net 225 and also receives node state data for node i (e.g., hᵢ(t−)) and neighboring nodes (e.g., neighboring node state data 210 of FIG. 2). Accordingly, node i state data 304 represents the node state data for node i (e.g., hᵢ(t−)), node d state data 306 represents the node state data for node d (e.g., h_{d}(t−)), node c state data 308 represents the node state data for node c (e.g., h_{c}(t−)), node b state data 310 represents the node state data for node b (e.g., h_{b}(t−)), node e state data 312 represents the node state data for node e (e.g., hₑ(t−)), and node f state data 314 represents the node state data for node f (e.g., h_{f}(t−)). Transformer component 235 generates input data including node i state change 316, node i state data 304, node d state data 306, node c state data 308, node b state data 310, node e state data 312, and node f state data 314. Transformer component 235 applies a trained transformer machine learning model to this input data to generate updated state data for node i and its neighboring nodes. For example, transformer component 235 generates node d updated state data 320 represented by h_{d}(t) according to the following equation h_{d}(t)=transformer (h_{d}(t−), mᵢ(t)), where transformer represents applying the trained transformer machine learning model to an input sequence including node d updated state data 320 and node i state change 316. Transformer component 235 similarly generates node i updated state data 318 (e.g., hᵢ(t)=transformer (hᵢ(t−), mᵢ(t)), node c updated state data 322 (e.g., h_{c}(t)=transformer (h_{c}(t−), mᵢ(t)), node b updated state data 324 (e.g., h_{b}(t)=transformer (h_{b}(t−), mᵢ(t)), node e updated state data 326 (e.g., hₑ(t)), and node f updated state data 328 (e.g., h_{f}(t)=transformer (h_{f}(t−), mᵢ(t)). The updated node state data represents how the nodes change based on the change in node i (e.g., mᵢ(t)) and therefore based on the underlying event. For example, if the event indicates that node i likes a certain topic, similar nodes (e.g., neighboring nodes) can be inferred to be more likely to like that topic and therefore their state data is updated. Further details regarding transformer component 235 and the trained machine learning model are described with reference to FIG. 4. Transformer component 235 sends the updated node state data (e.g., hᵢ(t), h_{d}(t), h_{c}(t), h_{b}(t), hₑ(t), and h_{f}(t)) to node aggregation component 160. Node aggregation component 160 receives the updated node state data and generates an encoding for node i (e.g., node i encoding 330) using the updated node state data. Further details regarding node aggregation component 160 and generating node encodings are described with reference to FIG. 5.

FIG. 4 illustrates another example computing system 400 that includes an event preprocessing component in accordance with some embodiments of the present disclosure. As shown in FIG. 4, transformer component 235 includes encoder 405 and decoder 415. Encoder 405 includes multi-head attention layer 402, add & norm layer 404, feed-forward layer 406, and add & norm layer 408. Decoder 415 includes masked multi-head attention layer 410, add & norm layers 412, 416, and 420, multi-head attention layer 414, and feed-forward layer 418.

Multi-head attention layer 402 receives inputs of input sequence 425 and computes output representations for each of the input tokens of input sequence 425 based on the inputs of input sequence 425. For example, multi-head attention layer 402 converts each input token of input sequence 425 into a query, keys, and values using query, key, and value matrices. Multi-head attention layer 402 computes the output representation of the input tokens of input sequence 425 as the weighted sum of the values of all of the input tokens of input sequence 425. Multi-head attention layer 402 computes the weights for the weighted sum by applying a compatibility function to the corresponding key and query for the value. For example, multi-head attention layer 402 uses a scaled dot product on the key and query of an input token to determine a weight to apply to a value of the input token. Multi-head attention layer 402 includes multiple attention blocks which each compute an output representation for the input token. Multi-head attention layer 402 aggregates the output representations of these attention blocks to generate a final output representation for multi-head attention layer 402.

Inputs of input sequence 425 include the state of a node (e.g., node i state data 304, node d state data 306, node c state data 308, node b state data 310, node e state data 312, and node f state data 314) at a given timestamp and state change for the relevant node as represented by the output of event neural net 225 (e.g., node i state change 316). Transformer component 235 feeds the output representation generated by multi-head attention layer 402 and residual connections from the inputs of input sequence 425 into add & norm layer 404. By including these residual connections, transformer component 235 ensures that it does not forget features of input sequence 425 during training. Add & norm layer 404 sums the output representation generated by multi-head attention layer 402 and the residual connections from inputs of input sequence 425 and applies a layer normalization to the result. In some embodiments, the add & normal layers generate node state change probabilities for the inputs of input sequence 425. For example, add & norm layer 408 generates estimated probabilities for updating the node state in response to the event (e.g., node i state change 316).

Transformer component 235 feeds the normalized output of add & norm layer 404 into feed-forward layer 406. Feed-forward layer 406 is a feed-forward network that receives the normalized output, feeds it through the hidden layers of feed-forward layer 406, and then feeds the output of feed-forward layer 406 into add & norm layer 408. Feed-forward layer 406 processes the information received from add & norm layer 404 and can update the hidden layers of feed-forward layer 406 based on the information (e.g., during training) and/or generate an output based on the hidden layers processing the information (e.g., during evaluation and/or inference). For example, during training, transformer component 235 updates the weights of the hidden layers of feed-forward layer 406 based on the inputs and the loss of the transformer system. As an alternative example, during evaluation and/or inference, the weights of the hidden layers of feed-forward layer 406 are used to determine the output representation of each of the input tokens of input sequence 425.

Transformer component 235 feeds the output of feed-forward layer 406 into add & norm layer 408 as well as residual connections from the output of add & norm layer 404. Add & norm layer 408 sums the output of feed-forward layer 406 with the residual connections from add & norm layer 404 and applies a layer normalization to the result to generate encoder output representation 435. Transformer component 235 feeds encoder output representation 435 into multi-head attention layer 414 of decoder 415 as explained below.

Masked multi-head attention layer 410 receives outputs of input sequence 425 and computes representations for each of the output tokens of input sequence 425 based on masked outputs of input sequence 425. For example, masked multi-head attention layer 410 computes representations for each of the output tokens of input sequence 425 based on previous output tokens while masking future output tokens (e.g., applies causal masking). Masked multi-head attention layer 410 therefore only computes representations using tokens that come before the token masked multi-head attention layer 410 is trying to predict. By masking future rewards, decoder 415 is prevented from results from later times to predict node state changes for a prior timestamp. Transformer component 235 feeds the representation generated by masked multi-head attention layer 410 and residual connections from the outputs of input sequence 425 into add & norm layer 412. Add & norm layer 412 sums the representation generated by masked multi-head attention layer 410 and the residual connections from outputs of input sequence 425 and applies a layer normalization to the result.

Transformer component 235 feeds the normalized output of add & norm layer 416 into multi-head attention layer 414. Multi-head attention layer 414 receives the normalized output of add & norm layer 412 as well as encoder output representation 435 from encoder 405 and generates a representation based on both. For example, multi-head attention layer 414 generates a representation using queries from the output of add & norm layer 412 and keys and values from encoder output representation 435. Transformer component 235 feeds the representation generated by multi-head attention layer 414 and residual connections from the output of add & norm layer 412 into add & norm layer 416. Add & norm layer 416 sums the representation generated by multi-head attention layer 414 and the residual connections from the output of add & norm layer 412 and applies a layer normalization to the result.

Transformer component 235 feeds the normalized output of add & norm layer 416 into feed-forward layer 418. Feed-forward layer 418 is a feed-forward network that receives the normalized output, feeds it through the hidden layers of feed-forward layer 418, and then feeds the output of feed-forward layer 418 into add & norm layer 420. Feed-forward layer 418 processes the information received from add & norm layer 416 and can update the hidden layers of feed-forward layer 418 based on the information (e.g., during training) and/or generate an output based on the hidden layers processing the information (e.g., during evaluation and/or inference). For example, during training, transformer component 235 updates the weights of the hidden layers of feed-forward layer 418 based on the inputs and the loss of the transformer system. As an alternative example, during evaluation and/or inference, the weights of the hidden layers of feed-forward layer 418 are used to determine the output out feed-forward layer 418.

Transformer component 235 feeds the output of feed-forward layer 418 into add & norm layer 420 as well as residual connections from the output of add & norm layer 416. Add & norm layer 420 sums the output of feed-forward layer 418 with the residual connections from add & norm layer 416 and applies a layer normalization to the result to generate an output. Transformer component 235 generates updated state data 445 from the output of add & norm layer 420. For example, transformer component 235 generates node i updated state data 318 from an input of node i state change 316 and node i state data 304. Similarly, transformer component 235 generates each of node d updated state data 320, node c updated state data 322, node b updated state data 324, node e updated state data 326, and node f updated state data 328 from node i state change 316 and the state data for the respective node. Transformer component 235 sends the updated state data 445 for each of the nodes to node aggregation component 160.

FIG. 5 illustrates an example computing system 500 that includes a node aggregation component in accordance with some embodiments of the present disclosure. As shown in FIG. 5, computing system 500 includes node aggregation component 160 and graph representation 505. Graph representation 505 is illustrated for the purpose of explanation to show how node i 510 connects to each of its neighboring nodes (e.g., node d 515, node c 520, node b 525, node e 530, and node f 535). Graph representation 505 therefore illustrates how the graph neural network connects the relevant nodes. For the purposes of explanation, a neighbor distance of two is used. Accordingly, the only nodes that are taken into account for determining the encoding of node i 510 are nodes within two connections of node i 510 (e.g., a 2-hop graph neural network). It shall be appreciated that different neighbor distances can be used to compute embeddings.

As shown in FIG. 5, node aggregation component 160 computes node i encoding 330 by applying an aggregation function 502 and a projection function 504 on node i 510 and neighboring nodes of graph representation 505. For example, node aggregation component 160 initializes the graph neural network with updated state data for the two-hop nodes (e.g., hᵢ(t), h_{d}(t), h_{c}(t), h_{b}(t), hₑ(t), and h_{f}(t)). For example, node aggregation component 160 sets

$${r}_{i}^{0} = {h}_{i} ( t ) ,$$

etc. Node aggregation component 160 uses this updated state data for the first layer of the computation (e.g., the nodes illustrated in the top of node aggregation component 160 as shown in FIG. 5). For each of the one-hop nodes, (e.g., node d 515, node c 520, and node b 525), node aggregation component 160 applies aggregation function 502 to their neighbors and then generates an updated representation for that node using the projection of the updated state data and the projection of the aggregation of its neighbors. For example, for the second layer (e.g., the nodes illustrated in the top of node aggregation component 160 as shown in FIG. 5), the second layer representation of node d 515 is computed using the projection of the first layer representation of node d 515 (e.g., h_{d}(t)) and the projection of the aggregation of the first layer representations of the neighbors of node d 515 (e.g., node i 510 with first layer representation hᵢ(t)).

Similarly, node aggregation component 160 computes node i encoding 330 using a projection of the aggregation of the second layer representation of the one-hop neighbors of node i 510 (e.g., node d 515, node c 520, and node b 525) and a projection of node i 510 itself. For example, node aggregation component 160 generates node i encoding 330 (represented by zᵢ(t)) according to the following equation:

$${z}_{i} ( t ) = {GNN}_{k - hop} ( {h}_{i} ( t ) ) where {z}_{i} ( t ) = {r}_{i}^{k} and$$

$${r}_{i}^{k} = tanh ( {W}_{k} \cdot {\sum }_{j ∈ N ( i )} \frac{{r}_{j}^{k - 1}}{\vert N ( i ) \vert} + {B}_{k} \cdot {r}_{i}^{k - 1} )$$

with W and B representing weights of the system and N(i) representing the number of neighbors for node i 510.

In some embodiments, node aggregation component 160 trains the machine learning model to generate node encoding using binary cross-entropy loss. For example, node aggregation component 160 uses both positive instances (e.g., a certain event occurring between two nodes) and negative instances (e.g., a certain event not occurring between nodes for a given time and/or random sampling of all nodes with no events associated with the given node). The loss can therefore be computed as

$$L = - {\sum }_{i} log ( \frac{{e}^{〈 {z}_{i} ( t ) \cdot {z}_{j} ( t ) 〉 / τ}}{{e}^{〈 {z}_{i} ( t ) \cdot {z}_{j} ( t ) 〉 / τ} + {\sum }_{neg} {e}^{〈 {z}_{i} ( t ) \cdot {z}_{neg} ( t ) 〉 / τ}} ) ,$$

where τ∈ [0.01,∞) and is a temperature parameter used to calibrate the model, zᵢ(t) is the encoding for node i, zⱼ(t) is the encoding for node j where the positive instances include an interaction between nodes i and j, and z_{neg}(t) is the encoding for the negative instance nodes.

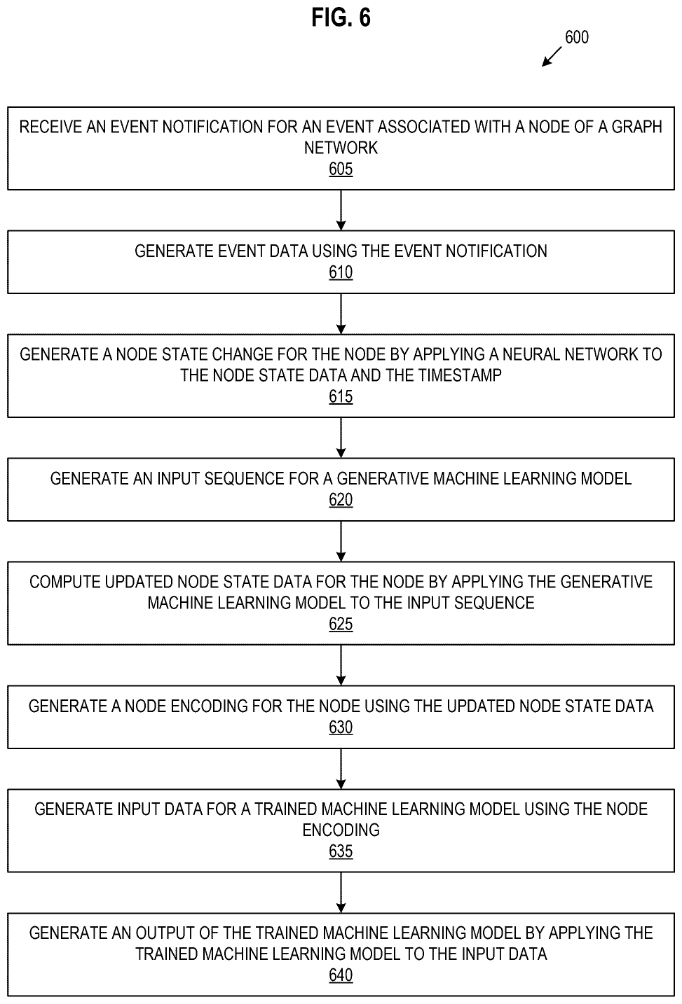

FIG. 6 is a flow diagram of an example method 600 to generate encodings for graph network evolutions in accordance with some embodiments of the present disclosure. The method 600 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 600 is performed by event preprocessing component 150 of FIG. 1. In other embodiments, the method 600 is performed by node aggregation component 160 of FIG. 1. In still other embodiments, parts of the method 600 are performed by event preprocessing component 150 and parts of the method 600 are performed by node aggregation component 160. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 605, the processing device receives an event notification for an event associated with a node of a graph network. For example, event preprocessing component 150 receives event notification 202 from user system 110. Further details regarding receiving an event notification for an event associated with a node of a graph network are described with reference to FIG. 2.

At operation 610, the processing device generates event data using the event notification. For example, event preprocessing component 150 generates event data 204 using event notification 202. In some embodiments, the event data includes a previous node state for nodes involved in the event, a timestamp of the event, and an event type. Further details regarding generating event data using the event notification are described with reference to FIG. 2.

At operation 615, the processing device generates a node state change for the node by applying a neural network to the node state data and the timestamp. For example, event preprocessing component 150 generates node state change 212 by applying event neural net 225 to the previous node states for nodes involved in the event, the timestamp of the event, and the event type. Further details regarding generating a node state change for the node by applying a neural network to the event data are described with reference to FIGS. 2 and 3.

At operation 620, the processing device generates an input sequence for a generative machine learning model. For example, event preprocessing component 150 generates input sequence 425 using node state change 212 and node state data 206. In some embodiments, the processing device generates input sequences for all neighboring nodes of the relevant node (e.g., all nodes within a neighbor distance). Further details regarding generating an input sequence for a generative machine learning model are described with reference to FIGS. 2-4.

At operation 625, the processing device computes updated node state data for the node by applying the generative machine learning model to the input sequence. For example, event preprocessing component 150 computes updated node state data 214 by applying a transformer machine learning model to input sequence 425. In some embodiments, the processing device computes updated node state data for all neighboring nodes of the relevant node (e.g., all nodes within a neighbor distance). Further details regarding computing updated node state data for the node by applying the generative machine learning model to the input sequence are described with reference to FIGS. 2 and 4.

At operation 630, the processing device generates a node encoding for the node using the updated node state data. For example, node aggregation component 160 generates node encoding 216 using updated node state data 214. In some embodiments, the processing device generates the node encoding using the updated node state data for the node and updated node state data for all neighboring nodes (e.g., all nodes within a neighbor distance). Further details regarding generating a node encoding for the node using the updated node state data are described with reference to FIGS. 2 and 5.

At operation 635, the processing device generates input data for a trained machine learning model using the node encoding. For example, machine learning model execution component 245 generates input data for a recommendation model using node encoding 216. Further details regarding generating input data for a trained machine learning model using the node encoding are described with reference to FIG. 2.

At operation 640, the processing device generates an output of the trained machine learning model by applying the trained machine learning model to the input data. For example, machine learning model execution component 245 generates a recommendation for a user of the online system by applying a recommendation model to node encoding 216. Further details regarding generating an output of the trained machine learning model by applying the trained machine learning model to the input data described with reference to FIG. 2.

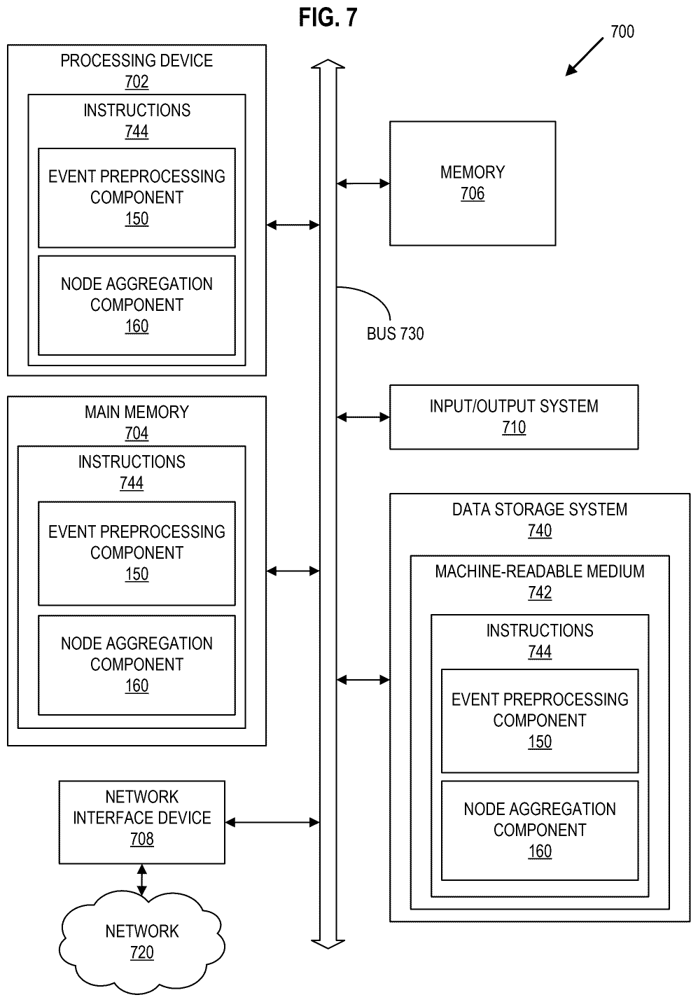

FIG. 7 illustrates an example machine of a computer system 700 within which a set of instructions for causing the machine to perform any one or more of the methodologies discussed herein, can be executed. In some embodiments, the computer system 700 can correspond to a component of a networked computer system (e.g., computing system 100 of FIG. 1) that includes, is coupled to, or utilizes a machine to execute an operating system to perform operations corresponding to event preprocessing component 150 and/or node aggregation component 160 of FIG. 1. The machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a smart phone, a tablet PC, a set-top box (STB), a Personal Digital Assistant (PDA), a cellular telephone, a web appliance, a server, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 700 includes a processing device 702, a main memory 704 (e.g., read-only memory (ROM), flash memory, dynamic random-access memory (DRAM) such as synchronous DRAM (SDRAM) or Rambus DRAM (RDRAM), etc.), a memory 706 (e.g., flash memory, static random-access memory (SRAM), etc.), an input/output system 710, and a data storage system 740, which communicate with each other via a bus 730.

Processing device 702 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 702 can also be one or more special-purpose processing devices such as an application specific integrated circuit (ASIC), a field programmable gate array (FPGA), a digital signal processor (DSP), network processor, or the like. The processing device 702 is configured to execute instructions 744 for performing the operations and steps discussed herein.

The computer system 700 can further include a network interface device 708 to communicate over the network 720. Network interface device 708 can provide a two-way data communication coupling to a network. For example, network interface device 708 can be an integrated-services digital network (ISDN) card, cable modem, satellite modem, or a modem to provide a data communication connection to a corresponding type of telephone line. As another example, network interface device 708 can be a local area network (LAN) card to provide a data communication connection to a compatible LAN. Wireless links can also be implemented. In any such implementation, network interface device 708 can send and receive electrical, electromagnetic, or optical signals that carry digital data streams representing various types of information.

The network link can provide data communication through at least one network to other data devices. For example, a network link can provide a connection to the world-wide packet data communication network commonly referred to as the “Internet,” for example through a local network to a host computer or to data equipment operated by an Internet Service Provider (ISP). Local networks and the Internet use electrical, electromagnetic, or optical signals that carry digital data to and from computer system computer system 700.

Computer system 700 can send messages and receive data, including program code, through the network(s) and network interface device 708. In the Internet example, a server can transmit a requested code for an application program through the Internet and network interface device 708. The received code can be executed by processing device 702 as it is received, and/or stored in data storage system 740, or other non-volatile storage for later execution.

The input/output system 710 can include an output device, such as a display, for example a liquid crystal display (LCD) or a touchscreen display, for displaying information to a computer user, or a speaker, a haptic device, or another form of output device. The input/output system 710 can include an input device, for example, alphanumeric keys and other keys configured for communicating information and command selections to processing device 702. An input device can, alternatively or in addition, include a cursor control, such as a mouse, a trackball, or cursor direction keys for communicating direction information and command selections to processing device 702 and for controlling cursor movement on a display. An input device can, alternatively or in addition, include a microphone, a sensor, or an array of sensors, for communicating sensed information to processing device 702. Sensed information can include voice commands, audio signals, geographic location information, and/or digital imagery, for example.

The data storage system 740 can include a machine-readable storage medium 742 (also known as a computer-readable medium) on which is stored one or more sets of instructions 744 or software embodying any one or more of the methodologies or functions described herein. The instructions 744 can also reside, completely or at least partially, within the main memory 704 and/or within the processing device 702 during execution thereof by the computer system 700, the main memory 704 and the processing device 702 also constituting machine-readable storage media.

In one embodiment, the instructions 744 include instructions to implement functionality corresponding to an event preprocessing component (e.g., event preprocessing component 150 of FIG. 1). In another embodiment, the instructions 744 include instructions to implement functionality corresponding to a node aggregation component (e.g., node aggregation component 160 of FIG. 1). In yet another embodiment, the instructions 744 include instructions to implement functionality corresponding to both an event preprocessing component and a node aggregation component (e.g., event preprocessing component 150 and node aggregation component 160 of FIG. 1). While the machine-readable storage medium 742 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Example 1. A method comprising: receiving an event notification for an event associated with a node of a graph network; generating event data using the event notification, wherein the event data comprises (i) node state data that represents an interaction of the node before a time of the event and (ii) a timestamp identifying the time of the event; generating a node state change for the node by applying a neural network to the node state data and the timestamp; generating an input sequence for a generative machine learning model, wherein the input sequence comprises the node state change and the node state data; computing updated node state data for the node by applying the generative machine learning model to the input sequence; generating a node encoding for the node using the updated node state data; generating input data for a trained machine learning model using the node encoding; and generating an output of the trained machine learning model by applying the trained machine learning model to the input data.

Example 2. The method of example 1, further comprising: retrieving node state data for one or more neighboring nodes of the node; generating one or more input sequences for the generative machine learning model, wherein a first input sequence of the one or more input sequences comprises (i) node state data for that neighboring node of the one or more neighboring nodes and (ii) the node state change for the node; and computing updated node state data for the one or more neighboring nodes by applying the generative machine learning model to the one or more input sequences, wherein generating the node encoding for the node further uses the updated node state data for the one or more neighboring nodes.

Example 3. The method of example 2, wherein generating the node encoding for the node comprises: aggregating the updated node state data for the one or more neighboring nodes.

Example 4. The method of any of examples 2-3, further comprising: determining the one or more neighboring nodes as nodes within a neighbor distance of the node.

Example 5. The method of any of examples 1-4, wherein the event further involves a second node of the graph network, wherein the event data further comprises node state data for the second node that represents interactions of the second node before the time of the event, and wherein generating the node state change further applies the neural network to the node state data for the second node.

Example 6. The method of example 5, wherein the event data further comprises a position vector for the node and the second node involved in the event and wherein generating the node state change further applies the neural network to the position vector.

Example 7. The method of any of examples 1-6, wherein the event data further comprises an event type for the event and wherein generating the node state change further applies the neural network to the event type.

Example 8. The method of any of examples 1-7, wherein generating the node state change is in response to receiving the event notification.

Example 9. The method of any of examples 1-8, wherein the graph network is for an online system, the event data is for a plurality of events of the online system involving the node, the event data comprises a plurality of node state data for states of the node at a plurality of times of the plurality of events and a plurality of timestamps identifying the plurality of times of the plurality of events, and generating the node state change further applies the neural network to the plurality of node state data and the plurality of timestamps.

Example 10. The method of any of examples 1-9, wherein generating the node encoding comprises: applying an encoding machine learning model trained using binary cross-entropy including positive and negative instances to the updated node state data.

Example 11. A system comprising: at least one memory device; and a processing device, operatively coupled with the at least one memory device, to: receive an event notification for an event associated with a node of a graph network; generate event data using the event notification, wherein the event data comprises (i) node state data that represents an interaction of the node before a time of the event and (ii) a timestamp identifying the time of the event; generate a node state change for the node by applying a neural network to the node state data and the timestamp; generate an input sequence for a generative machine learning model, wherein the input sequence comprises the node state change and the node state data; compute updated node state data for the node by applying the generative machine learning model to the input sequence; generate a node encoding for the node using the updated node state data; generate input data for a trained machine learning model using the node encoding; and generate an output of the trained machine learning model by applying the trained machine learning model to the input data.

Example 12. The system of example 11, wherein the processing device is further to: retrieve node state data for one or more neighboring nodes of the node; generate one or more input sequences for the generative machine learning model, wherein a first input sequence of the one or more input sequences comprises (i) node state data for that neighboring node of the one or more neighboring nodes and (ii) the node state change for the node; and compute updated node state data for the one or more neighboring nodes by applying the generative machine learning model to the one or more input sequences, wherein generating the node encoding for the node further uses the updated node state data for the one or more neighboring nodes.

Example 13. The system of example 12, wherein generating the node encoding for the node comprises: aggregating the updated node state data for the one or more neighboring nodes.

Example 14. The system of any of examples 12-13, wherein the processing device is further to: determine the one or more neighboring nodes as nodes within a neighbor distance of the node.

Example 15. The system of any of examples 11-14, wherein the event data further comprises an event type for the event and wherein generating the node state change further applies the neural network to the event type.

Example 16. The system of any of examples 11-15, wherein generating the node state change is in response to receiving the event notification.

Example 17. The system of any of examples 11-16, wherein the graph network is for an online system, the event data is for a plurality of events of the online system involving the node, the event data comprises a plurality of node state data for states of the node at a plurality of times of the plurality of events and a plurality of timestamps identifying the plurality of times of the plurality of events, and generating the node state change further applies the neural network to the plurality of node state data and the plurality of timestamps.

Example 18. The system of any of examples 11-17, wherein generating the node encoding comprises: applying an encoding machine learning model trained using binary cross-entropy including positive and negative instances to the updated node state data.

Example 19. A system comprising: at least one memory device; and a processing device, operatively coupled with the at least one memory device, to: receive an event notification for an event associated with a first node and a second node of a graph network; generate event data using the event notification, wherein the event data comprises (i) first node state data that represents an interaction of the first node before a time of the event, (ii) second node state data that represents an interaction of the second node before the time of the event, and (iii) a timestamp identifying the time of the event; generate a first node state change for the first node by applying a neural network to the first node state data, the second node state data, and the timestamp; generate a second node state change for the second node by applying the neural network to the first node state data, the second node state data, and the timestamp; generate a first input sequence for a generative machine learning model, wherein the first input sequence comprises the first node state change and the first node state data; generate a second input sequence for the generative machine learning model, wherein the second input sequence comprises the second node state change and the second node state data; compute updated first node state data for the first node by applying the generative machine learning model to the first input sequence; compute updated second node state data for the second node by applying the generative machine learning model to the second input sequence; generate a node encoding for the first node using the updated first node state data and the updated second node state data; generate input data for a trained machine learning model using the node encoding; and generate an output of the trained machine learning model by applying the trained machine learning model to the input data.

Example 20. The system of example 19, wherein the event data further comprises a position vector and wherein generating the first node state change and the second node state further applies the neural network to the position vector.

The techniques described herein may be implemented with privacy safeguards to protect user privacy. Furthermore, the techniques described herein may be implemented with user privacy safeguards to prevent unauthorized access to personal data and confidential data. The training of the AI (Artificial Intelligence) models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may choose to share personal data with different platforms to provide services that are more tailored to the users. In instances where the users choose not to share personal data with the platforms, the choices made by the users will not have any impact on their ability to use the services that they had access to prior to making their choice. According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI (Artificial Intelligence) models. The techniques described herein may utilize tools for anonymizing member and customer data. For example, user's personal data may be redacted and minimized in training datasets for training AI models through delexicalization tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system, such as the computing system 100, can carry out the computer-implemented method 600 in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

Illustrative examples of the technologies disclosed herein are provided below. An embodiment of the technologies may include any of the examples or a combination of the described below.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
receiving an event notification for an event associated with a node of a graph network;
generating event data using the event notification, wherein the event data comprises (i) node state data that represents an interaction of the node before a time of the event and (ii) a timestamp identifying the time of the event;
generating a node state change for the node by applying a neural network to the node state data and the timestamp;
generating an input sequence for a generative machine learning model, wherein the input sequence comprises the node state change and the node state data;
computing updated node state data for the node by applying the generative machine learning model to the input sequence;
generating a node encoding for the node using the updated node state data;
generating input data for a trained machine learning model using the node encoding; and
generating an output of the trained machine learning model by applying the trained machine learning model to the input data.

2. The method of claim 1, further comprising:
retrieving node state data for one or more neighboring nodes of the node;
generating one or more input sequences for the generative machine learning model, wherein a first input sequence of the one or more input sequences comprises (i) node state data for that neighboring node of the one or more neighboring nodes and (ii) the node state change for the node; and
computing updated node state data for the one or more neighboring nodes by applying the generative machine learning model to the one or more input sequences, wherein generating the node encoding for the node further uses the updated node state data for the one or more neighboring nodes.

3. The method of claim 2, wherein generating the node encoding for the node comprises:
aggregating the updated node state data for the one or more neighboring nodes.

4. The method of claim 2, further comprising:
determining the one or more neighboring nodes as nodes within a neighbor distance of the node.

5. The method of claim 1, wherein the event further involves a second node of the graph network, wherein the event data further comprises node state data for the second node that represents interactions of the second node before the time of the event, and wherein generating the node state change further applies the neural network to the node state data for the second node.

6. The method of claim 5, wherein the event data further comprises a position vector for the node and the second node involved in the event and wherein generating the node state change further applies the neural network to the position vector.

7. The method of claim 1, wherein the event data further comprises an event type for the event and wherein generating the node state change further applies the neural network to the event type.

8. The method of claim 1, wherein generating the node state change is in response to receiving the event notification.

9. The method of claim 1, wherein the graph network is for an online system, the event data is for a plurality of events of the online system involving the node, the event data comprises a plurality of node state data for states of the node at a plurality of times of the plurality of events and a plurality of timestamps identifying the plurality of times of the plurality of events, and generating the node state change further applies the neural network to the plurality of node state data and the plurality of timestamps.

10. The method of claim 1, wherein generating the node encoding comprises:
applying an encoding machine learning model trained using binary cross-entropy including positive and negative instances to the updated node state data.

11. A system comprising:
at least one memory device; and
a processing device, operatively coupled with the at least one memory device, to:
receive an event notification for an event associated with a node of a graph network;
generate event data using the event notification, wherein the event data comprises (i) node state data that represents an interaction of the node before a time of the event and (ii) a timestamp identifying the time of the event;
generate a node state change for the node by applying a neural network to the node state data and the timestamp;
generate an input sequence for a generative machine learning model, wherein the input sequence comprises the node state change and the node state data;
compute updated node state data for the node by applying the generative machine learning model to the input sequence;
generate a node encoding for the node using the updated node state data;
generate input data for a trained machine learning model using the node encoding; and
generate an output of the trained machine learning model by applying the trained machine learning model to the input data.

12. The system of claim 11, wherein the processing device is further to:
retrieve node state data for one or more neighboring nodes of the node;
generate one or more input sequences for the generative machine learning model, wherein a first input sequence of the one or more input sequences comprises (i) node state data for that neighboring node of the one or more neighboring nodes and (ii) the node state change for the node; and
compute updated node state data for the one or more neighboring nodes by applying the generative machine learning model to the one or more input sequences, wherein generating the node encoding for the node further uses the updated node state data for the one or more neighboring nodes.

13. The system of claim 12, wherein generating the node encoding for the node comprises:
aggregating the updated node state data for the one or more neighboring nodes.

14. The system of claim 12, wherein the processing device is further to:
determine the one or more neighboring nodes as nodes within a neighbor distance of the node.

15. The system of claim 11, wherein the event data further comprises an event type for the event and wherein generating the node state change further applies the neural network to the event type.

16. The system of claim 11, wherein generating the node state change is in response to receiving the event notification.

17. The system of claim 11, wherein the graph network is for an online system, the event data is for a plurality of events of the online system involving the node, the event data comprises a plurality of node state data for states of the node at a plurality of times of the plurality of events and a plurality of timestamps identifying the plurality of times of the plurality of events, and generating the node state change further applies the neural network to the plurality of node state data and the plurality of timestamps.

18. The system of claim 11, wherein generating the node encoding comprises:
applying an encoding machine learning model trained using binary cross-entropy including positive and negative instances to the updated node state data.

19. A system comprising:
at least one memory device; and
a processing device, operatively coupled with the at least one memory device, to:
receive an event notification for an event associated with a first node and a second node of a graph network;
generate event data using the event notification, wherein the event data comprises (i) first node state data that represents an interaction of the first node before a time of the event, (ii) second node state data that represents an interaction of the second node before the time of the event, and (iii) a timestamp identifying the time of the event;
generate a first node state change for the first node by applying a neural network to the first node state data, the second node state data, and the timestamp;
generate a second node state change for the second node by applying the neural network to the first node state data, the second node state data, and the timestamp;
generate a first input sequence for a generative machine learning model, wherein the first input sequence comprises the first node state change and the first node state data;
generate a second input sequence for the generative machine learning model, wherein the second input sequence comprises the second node state change and the second node state data;
compute updated first node state data for the first node by applying the generative machine learning model to the first input sequence;
compute updated second node state data for the second node by applying the generative machine learning model to the second input sequence;
generate a node encoding for the first node using the updated first node state data and the updated second node state data;
generate input data for a trained machine learning model using the node encoding; and
generate an output of the trained machine learning model by applying the trained machine learning model to the input data.

20. The system of claim 19, wherein the event data further comprises a position vector and wherein generating the first node state change and the second node state further applies the neural network to the position vector.
